(19) United States
(12) Patent Application Publication
(10) Pub. No.: US 2021/0295136 A1
(43) Pub. Date: Sep. 23, 2021

(54) Improvement of Prediction Performance Using Asymmetric Tanh Activation Function

(71) Applicant: SK TELECOM CO., LTD., Seoul (KR)

(72) Inventor: Yong Hee HAN, Seoul (KR)

(21) Appl. No.: 17/267,360

(22) PCT Filed: Oct. 11, 2019
(86) PCT No.: PCT/KR2019/013316

§ 371 Date: Feb. 9, 2021

(30) Foreign Application Priority Data
Oct. 29, 2018 (KR) 10-2018-0129587

(51) Int. Cl. G06N 3/04; G06N 3/08

(52) U.S. Cl. CPC G06N 3/0481; G06N 3/08

(57) ABSTRACT

The present disclosure in at least one aspect provides an asymmetric hyperbolic tangent (tanh) function which can be used as an activation function irrespective of the structure of a neural network. The activation function provided limits an output range thereof to between a maximum value and a minimum value of a variable to be predicted. The activation function provided is suitable for a regression problem which requires the prediction of a wide range of real values depending on input data.

### CROSS-REFERENCE TO RELATED APPLICATION

This application claims priority from Korean Patent Application No. 10-2018-0129587 filed on Oct. 29, 2018, the disclosure of which is incorporated by reference herein in its entirety.

### TECHNICAL FIELD

The present disclosure in some embodiments relates to an artificial neural network.

### BACKGROUND

The statements in this section merely provide background information related to the present disclosure and do not necessarily constitute prior art.

Artificial neural networks have major application fields, one of which is a regression analysis that predicts a continuous target variable, such as power usage prediction and weather prediction.

Prediction values in the regression analysis may be in the range of [0, 1] or [−1, 1] depending on the characteristics of the data inputted to the neural network, or they may be real numbers including a negative number without a specific limitation.

Among the components of the neural network, an activation function is a component that performs a linear or nonlinear transform on the input data. An appropriate activation function is selected for application to the end of the neural network depending on the range of the prediction values, and utilizing an activation function having the same output range as the prediction values effects a reduced prediction error. For example, with any possible changes in the input value, the sigmoid function suppresses or squashes the output value to [0, 1], and the tanh function limits the same to [−1, 1]. Therefore, it is a typical practice to use, as the end activation function, the sigmoid function for prediction values in the range of [0, 1] (as in FIG. 1 at (a)), the tanh function for prediction values in the range of [−1, 1] (as in FIG. 1 at (b)), and the linear function for predicting real numbers with no limit to its range (as in FIG. 1 at (c). However, unlike the sigmoid function or the tanh function, the linear function when used as the activation function for neurons of the output layer may generate an increased prediction error due to the unlimited ranges of function values.

When the prediction range exceeds the output range of the activation function to be used, data preprocessing, such as normalization, may be considered to scale the range of input data to reduce the prediction range so that the range of prediction values may be limited to be [0, 1] or [−1, 1]. However, the scaling may result in severe distortion in the data variance, making it often difficult to limit the range of the prediction values to [0, 1] or [−1, 1], resulting in the range of prediction values frequently becoming that of substantially real values.

Therefore, regression analysis is required to face frequent occasions of predicting a wide range of real values depending on the input data.

### SUMMARY

### Technical Problem

The present disclosure in at least one embodiment seeks to introduce a new activation function capable of reducing a prediction error compared to existing activation functions for data having such a wide prediction range.

### Technical Solution

At least one aspect of the present disclosure provides a method, implemented by a computer, for processing data representing an actual phenomenon by using a neural network configured to model an actual data pattern, including at each node of an output layer of the neural network, computing weighted sum of input values, the input values at each node of the output layer of the neural network being output values from nodes of a last hidden layer of at least one hidden layer of the neural network, and at each node of the output layer of the neural network, applying a nonlinear activation function to the weighted sum of the input values to generate output value, wherein the nonlinear activation function has an output range with an upper limit and a lower limit that are respectively bounded by a maximum value and a minimum value of data inputted to a relevant node of the input layer of the neural network.

Another aspect of the present disclosure provides an apparatus for processing data representing an actual phenomenon by using a neural network configured to model an actual data pattern, including at least one processor, and at least one memory in which instructions are recorded. The instructions cause when executed in the processor, the processor to perform the method as described above.

Yet another aspect of the present disclosure provides an apparatus for performing a neural network operation for a neural network configured to model an actual data pattern to process data representing an actual phenomenon. The apparatus includes a weighted sum operation unit and an output operation unit. The weighted sum operation unit is configured to receive input values and weights for nodes of an output layer of the neural network and to generate a plurality of weighted sums for the nodes of the output layer of the neural network based on the input values and the weights that are received, the input values at each node of the output layer of the neural network being output values for nodes of a last hidden layer of at least one hidden layer of the neural network. The output operation unit is configured to apply an activation function to weighted sum of each node of the output layer of the neural network to generate output value for each node of the output layer of the neural network. Here, the nonlinear activation function has an output range with an upper limit and a lower limit that are respectively bounded by a maximum value and a minimum value of a variable to be predicted at a relevant node of the output layer of the neural network.

In some embodiments, the nonlinear activation function is expressed by an equation:

$$f ( x ) = \{ \begin{matrix}tanh ( \frac{x}{max / s} ) \times max & if x > 0 \\ tanh ( \frac{x}{min / s} ) \times min & else\end{matrix} or \\ f ( x ) = \{ \begin{matrix}tanh ( \frac{x}{max} ) \times max & if x > 0 \\ tanh ( \frac{x}{min} ) \times min & else\end{matrix}$$

In the equations, x is a weighted sum of the input values at the relevant node of the output layer of the neural network, max and min are respectively the maximum value and the minimum value of the variable to be predicted at the relevant node of the output layer of the neural network, and ‘s’ is a parameter that adjusts a derivative of the nonlinear activation function. Parameter ‘s’ may be a hyper-parameter that can be set or tuned by the developer with prior knowledge, or parameter ‘s’ may be put to optimization (i.e., training) along with the main variable, i.e., the weight set of respective nodes via training of the neural network.

### Advantageous Effects

As described above, the present disclosure uses an asymmetric tanh function as an activation function, which can reflect a minimum value and a maximum value of a variable to be predicted. Accordingly, the prediction error can be reduced by limiting the range of the prediction values to the minimum value and the maximum value of the prediction variable.

Additionally, according to at least one aspect of the present disclosure, the activation function includes a parameter ‘s’ which can adjust a derivative of the activation function, and the steeper the derivative, the smaller the range of weights of the neural network, so that the parameter ‘s’ can perform a regularization function for the neural network. This regularization has an effect of reducing an overfitting problem that exhibits good prediction results only on the learned data.

### BRIEF DESCRIPTION OF DRAWINGS

FIG. 1 is graphs of sigmoid, tanh, and linear functions that are well known as example activation functions.

FIG. 2 is a diagram of a representative autoencoder in its simplest form.

FIG. 3 is a graph of an exemplary final activation function provided by at least one embodiment of the present disclosure for a variable x that varies in the range of [−5, 3].

FIG. 4 shows statistical analysis results for a portion of a “credit card fraud detection” data set.

FIG. 5 is a schematic diagram of a structure of a stacked autoencoder used for “credit card fraud detection.”

FIG. 6 is diagrams of credit card fraudulent transaction detection performances according to a conventional method that applies a linear function to a final activation function of an autoencoder and according to a method of the present disclosure that applies an asymmetric tanh function to the same, respectively.

FIG. 7 is a graph of an asymmetric tanh as a hyper-parameter value changes.

FIG. 8 is a table showing the variance of a neuron weight and the variance of encoded data by the hyper-parameter values.

FIG. 9 is maps that visualize the regularization effect on changes in the hyper-parameter.

FIG. 10 is a diagram of an exemplary system in which at least one embodiment of the present disclosure is possibly implemented.

FIG. 11 is a flow diagram of a method of processing data representing an actual phenomenon by using a neural network configured to model an actual data pattern.

FIG. 12 is an exemplary functional block diagram of a neural network processing apparatus for performing neural network operations.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

According to at least one aspect, the present disclosure provides an asymmetric hyperbolic tangent (tanh) function that is usable as an activation function for neural networks regardless of their structures such as an autoencoder, a convolutional neural network (CNN), a recurrent neural network (RNN), a fully-connected neural network, and the like. Hereinafter, an autoencoder, which is one of the neural networks, is illustrated to define an activation function provided by the present disclosure, and its usefulness in practical applications is presented.

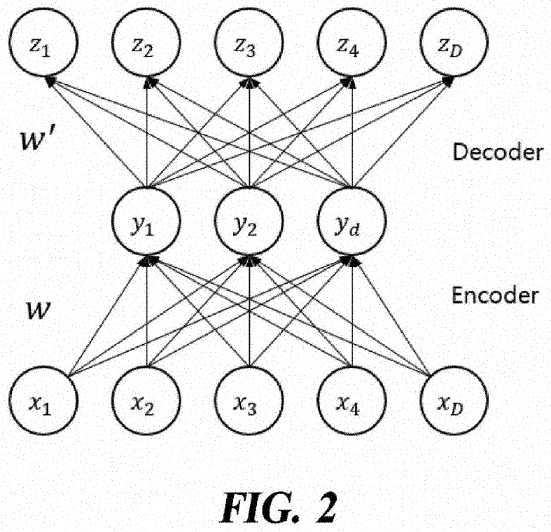

FIG. 2 is a diagram of a representative autoencoder in its simplest form.

The autoencoder has the input and output in the same dimension, and its goal of learning is to best approximate the output to the input. As illustrated in FIG. 2, the autoencoder consists of an encoder and a decoder. The encoder receives high-dimensional data and encodes the same into low-dimensional data. The decoder serves to decode the low-dimensional data to reconstruct the original high-dimensional data. In this process, the autoencoder is trained to reduce the difference between the original input data and the reconstructed data. Therefore, the autoencoder becomes a network that compresses the input data into low-dimensional data and then causes the latter to regress to the original data.

The autoencoder can converge to a network that can reproduce the distribution and characteristics of the input data as the training progresses. The converged network may be used for two purposes.

The first use of the converged network is in dimension reduction. In the example of FIG. 2, high-dimensional (D-dimensional) data has been reduced to low-dimensional (d-dimensional) data via the encoder. The fact that the reduced data can regress by the decoder back to high-dimensional data means that despite its low-dimensional status, the reduced data still contains significant information (often referred to as “latent information”) that can reproduce the input data. In other words, the autoencoder is occasionally used as a feature extractor by using such property that the information is compressed in the process of being encoded from the input layer into the hidden layer. This encoded data (i.e., extracted features) have a low-dimensional status so that in an additional data analysis, such as clustering, higher accuracy can be achieved compared to high-dimensional original data. Here, the neural network may be considered to possess representativeness or generalization for the data.

The second use of the autoencoder as being the converged network is in anomaly detection. For example, an autoencoder is widely used to solve a class imbalance problem with a significant difference in the number of each class in the data, such as when using, as inputs, sensor data of various sensors installed in manufacturing equipment having a failure rate of approximately 0.1%. Where the autoencoder has been trained by using just the sensor data acquired during the normal operation of the manufacturing equipment, it may be responsive to data inputted when in failure for detecting the state of anomaly from the autoencoder having such regression error (i.e., the difference between the input data and the decoded data) that is relatively larger than when in normal. This is because the autoencoder has been trained to reproduce normal data exclusively well (i.e., perform regression).

The operation of the autoencoder for encoding and then decoding variable x can be seen as performing a prediction (regression) of the value in the range over which the variable x varies. As mentioned in the background of the present disclosure, in an output layer of an autoencoder, utilizing an activation function having the same output range as the prediction values effects a reduced prediction error.

At least one aspect of the present disclosure introduces to data having a wide prediction range a new activation function that allows prediction with smaller error compared to an existing linear activation function. The new activation function limits its output range between the maximum value and the minimum value of the variable to be predicted.

The activation function provided is as follows.

$$f ( x ) = \{ \begin{matrix}tanh ( \frac{x}{max} ) \times max & if x > 0 \\ tanh ( \frac{x}{min} ) \times min & else\end{matrix} \qquad Equation 1$$

Here, max and min are the maximum value and the minimum value of the variable to be predicted in the relevant node (neuron), and x is the weighted sum of the input values of the relevant node.

According to Equation 1, if x is greater than zero, the upper limit of the output range of the activation function is the maximum value ‘max’ of variable x, since tanh(x/max) is multiplied by maximum value ‘max’ of the variable. When x is less than or equal to zero, the lower limit of the output range of the activation function is minimum value ‘min’ of variable x, since tanh(x/min) is multiplied by minimum value ‘min’ of variable x. Here, the use of x/max and x/min instead of x at the input of tanh ( ) is for the derivative near x=0 to have the same value (approximately 1) as the existing tanh function.

Assume that there is variable x that varies in the range of [−5, 3]. Referring to Equation 1, the exemplary final activation function provided by the present disclosure for variable x that varies in the range of [−5, 3] can be expressed as:

$$f ( x ) = \{ \begin{matrix}tanh ( \frac{x}{3} ) \times 3 & if x > 0 \\ tanh ( \frac{x}{- 5} ) \times ( - 5 ) & else\end{matrix} \qquad Equation 2$$

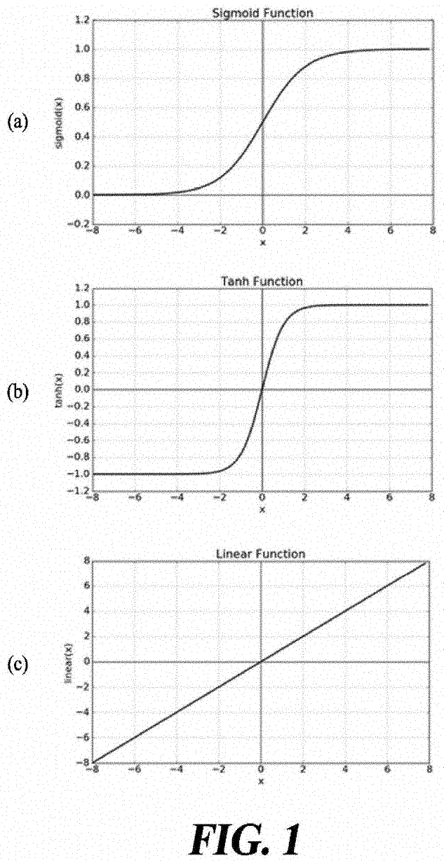

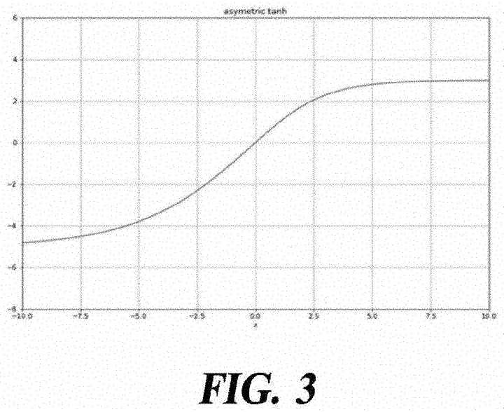

FIG. 3 is a graph of an exemplary final activation function provided by at least one embodiment of the present disclosure for variable x that varies in the range of [−5, 3]. Unlike the tanh function illustrated in FIG. 1, which is anti-symmetric with values outputted between −1 and 1 about 0, the activation function as illustrated in FIG. 3 is asymmetric with the upper and lower limits of the output range. In other words, the activation function provided by the present disclosure is asymmetric centering around 0, as long as the maximum value and the minimum value of a variable to be predicted are not equal to each other. Thus, the activation function provided may be referred to as an asymmetric hyperbolic tangent (tanh) function.

The following describes the utility of the asymmetric hyperbolic tangent function provided by the present disclosure in a practical application associated with anomaly detection. Various attempts are being made to detect fraudulent transactions by using an autoencoder, considering the fraudulent transaction data as some sort of anomaly data. In other words, when the fraudulent transaction data is input to the autoencoder trained with only normal transaction data, the regression error is made larger than that of the normal transaction, and thus it is determined as a fraudulent transaction.

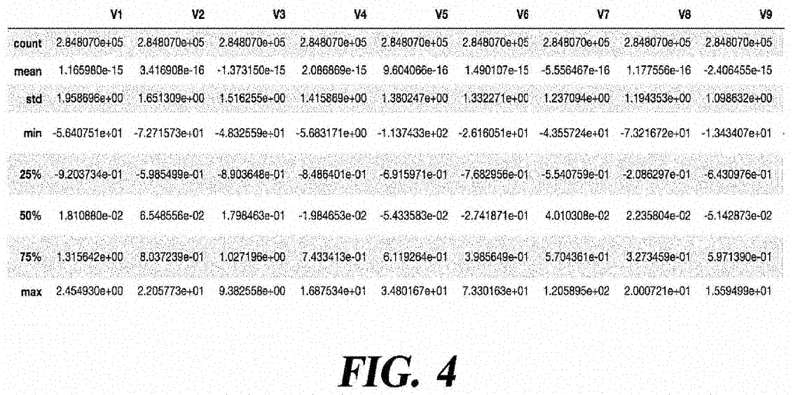

FIG. 4 shows statistical analysis results for a portion of a “credit card fraud detection” data set. A “credit card fraud detection” data set is a credit card transaction data in which fraudulent transaction data and normal transaction data are mixed, and it is published for research on “https://www.kaggle.com/mlg-ulb/creditcardfraud.”

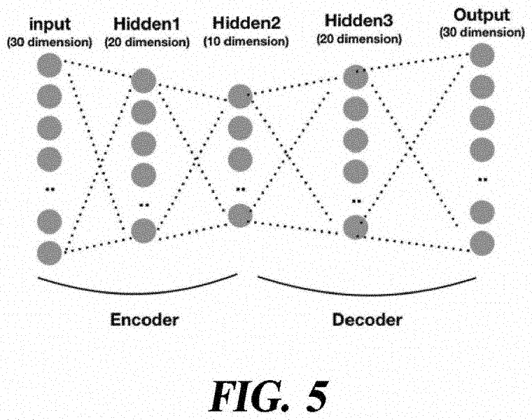

FIG. 5 is a schematic diagram of a structure of a stacked autoencoder used for “credit card fraud detection.” The stacked rule autoencoder is a structure having several hidden layers, which can represent a much more diverse function than the structure of FIG. 2. The stacked autoencoder illustrated in FIG. 5 is composed of encoders that receive and reduce (encode) a 30-dimensional variable to 20-dimensional and 10-dimensional encoded data, respectively, and decoders that reconstruct 10-dimensional encoded data to 20-dimensional and 30-dimensional variables, respectively. A second hidden layer composed of the lowest 10-dimensional layer (i.e., ten nodes) has the lowest dimension among the three hidden layers and is often referred to as a ‘bottleneck hidden layer’. The output values of the bottleneck hidden layer in this neural network are the most abstracted features, also referred to as bottleneck features.

According to the present disclosure, the asymmetric tanh function as determined in consideration of the minimum value and the maximum value for each variable is used as an activation function applied to the relevant final nodes (neurons).

In the data statistics shown in FIG. 4, the minimum value ‘min’ and maximum value ‘max’ of variable V1 are −5.640751e+01 and 2.45930, respectively. Applying this to Equation 1, the activation function according to the present disclosure utilized for the final node associated with variable V1 may be expressed by Equation 3.

$$f ( x ) = \{ \begin{matrix}tanh ( \frac{x}{2.45930} ) \times 2.45930 & if x > 0 \\ tanh ( \frac{x}{- 5.640751 e + 01} ) \times ( - 5.640751 e + 01 ) & else\end{matrix} \qquad Equation 3$$

In this manner, asymmetric tanh functions are applied to the activation function of the final node of the autoencoder, one each for each of thirty variables.

FIG. 6 is diagrams of credit card fraudulent transaction detection performances according to a conventional method that utilizes a linear function as a final activation function of an autoencoder and according to a method of the present disclosure that utilizes an asymmetric tanh function as the final activation function, respectively.

FIG. 6 shows at (a) a confusion matrix that is the resultant performance of a stacked autoencoder using the conventional linear function as a final activation function and shows at (b) a confusion matrix the resultant performance of a stacked autoencoder using the present asymmetric tanh function as a final activation function. As for “false positive errors” that represent the detection of normal transactions as fraudulent transactions, the conventional method exhibits 712 errors, whereas the scheme according to the present disclosure exhibits 134 less to be 578 errors. This confirms that “false positive errors” have been reduced substantially by about 18.8%. According to the present disclosure, detections of fraudulent transactions as normal transactions, that is, “false negative errors” have been reduced slightly from 19 to 18 errors, and the number of times that the fraudulent transaction is properly detected increased slightly from 79 to 80. As a side note, the fraud detection method was to obtain the sum of the average of reconstruction errors of the non-fraud data (normal transactions) and the standard deviation for each of the learned autoencoder models and to use the sum as a threshold for determining the fraud/non-fraud. If the reconstruction error is greater than the threshold value, it is determined as a fraudulent transaction. In this case, mean squared errors (MSEs) were used for the reconstruction errors.

As described above, one of the main uses of an autoencoder is dimension reduction. The output of the encoder has a lower dimension than that of the input data. If the autoencoder is trained to possess a generalization for the input data, the low-dimensional intermediate output also has significant information that can be representative of the input data.

A commonly used method for the intermediate output, i.e., encoded data to have a generalization is L1 regularization or L2 regularization. This is intended to render the weights ‘w’ of the neuron to congregate as values within a small range, thereby preventing overfitting and generalizing a model to have better generalization.

The present disclosure in at least one embodiment offers a parameter capable of adjusting a derivative of an asymmetric tanh function as a novel regularization means. Equation 4 defines the asymmetric tanh function with the addition of the parameter ‘s’.

$$f ( x ) = \{ \begin{matrix}tanh ( \frac{x}{max / s} ) \times max & if x > 0 \\ tanh ( \frac{x}{min / s} ) \times min & else\end{matrix} \qquad Equation 4$$

Here, max and min are the maximum and minimum values of the variable x to be predicted by the relevant node of the output layer. Thus, with an autoencoder, max and min are each a minimum value and a maximum value of data inputted to the relevant node of the input layer of the autoencoder. s is a parameter that adjusts the derivative of the nonlinear activation function.

According to Equation 4, if x, an input to the tanh operation is greater than 0, x is replaced with x/(max/s) as the input, and when x is equal to or less than 0, x is replaced with x/(min/s) to perform the tanh operation.

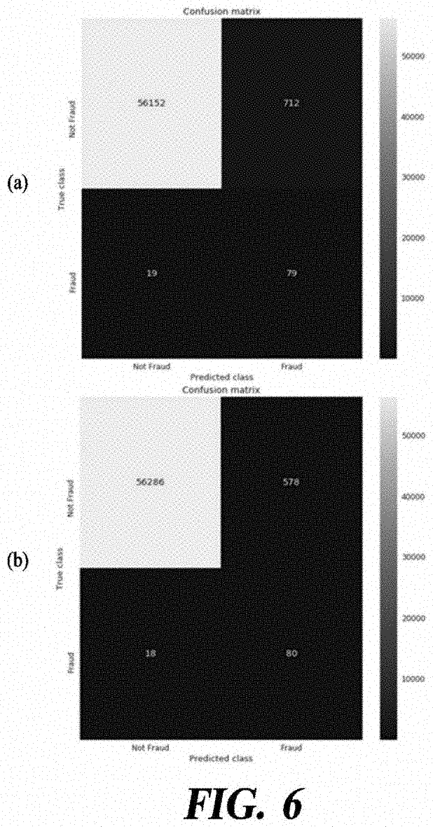

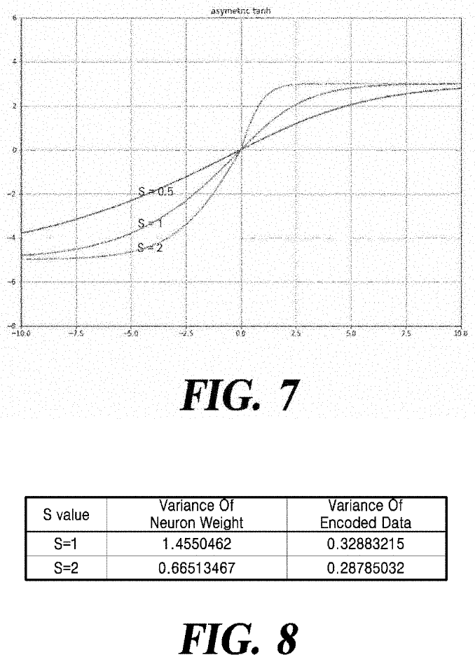

FIG. 7 is a graph of an asymmetric tanh parameter ‘s’ changes. The larger the ‘s’, the more the derivative of the graph, resulting in proportionally narrowed useful range and in turn lowered variation of the weight ‘w’ of the neuron. The result is obtaining an effect similar to the existing L1 regularization or L2 regularization.

The effect of regularization may be determined by the weight of the neuron and the variance of the outputs of the encoder. It can be seen that the lower the variance, the greater the effect of regularization. As shown in the table of FIG. 8, when s=2 rather than when s=1, the variances of both weight w and the encoded data are lowered.

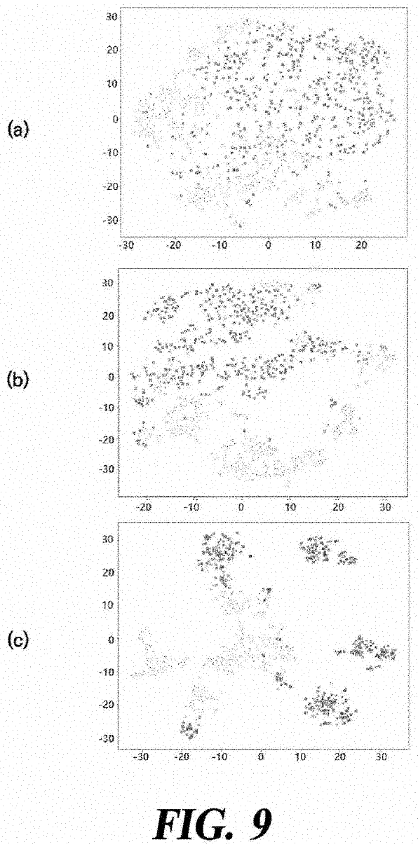

FIG. 9 is maps that visualize the regularization effect on changes in the hyper-parameter ‘s’. The visualization of FIG. 9 was obtained by processing encoded 10-dimensional data with t-stochastic neighbor embedding (t-SNE). FIG. 9 shows at (a) where ‘s’ is 1 that fraudulent transactions and normal transactions are very difficult to distinguish (to perform clustering) therebetween due to their mixed presence, whereas at (b) where ‘s’ is 2 an improvement that features the fraudulent transactions and the normal transactions that are easier to distinguish. This shows that low-dimensional encoded data can be secured with better generalization through tuning or optimization of parameter ‘5’.

This parameter ‘s’ may be a hyper-parameter that can be set or tuned by the developer with prior knowledge, or parameter ‘s’ may be put to optimization (i.e., training) along with the main variable, i.e., the weight set of respective nodes via training of the neural network. FIG. 9 shows at (c) a visualization map according to ‘s’ trained by the neural network and normalization that features much better clustering between the fraudulent transactions and the normal transactions than with the parameters of (a) and (b).

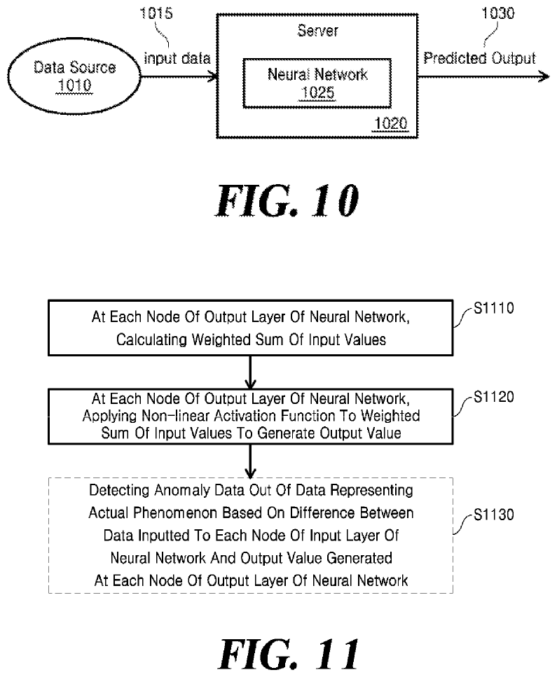

FIG. 10 is a diagram of an exemplary system in which at least one embodiment of the present disclosure is possibly implemented.

The system includes a data source 1010. The data source 1010 may be, for example, a database, a communication network, or the like. From the data source 1010, an input data 1015 is sent to a server 1020 for processing. The input data 1015 may be, for example, a numerical value, voice, text, image data, or the like. The server 1020 includes a neural network 1025. The input data 1015 is supplied to the neural network 1025 for processing. The neural network 1025 provides a predicted or decoded output 1030. The neural network 1025 represents a model that characterizes the relationship between the input data 1015 and the predicted output 1030.

According to an exemplary embodiment of the present disclosure, the neural network 1025 includes an input layer and at least one hidden layer, and an output layer, wherein the output values from the nodes of the last hidden layer of the at least one hidden layer are inputted to the respective nodes of the output layer. Each node of the output layer applies a nonlinear activation function to the weighted sum of the input values to generate output value. Here, the nonlinear activation function has an output range with an upper limit and a lower limit that are respectively bounded by a maximum value and a minimum value of input data inputted to the relevant node of the input layer of the neural network. The nonlinear activation function may be expressed by Equation 1 or Equation 4 described above. In applications related to feature extraction, output values from nodes of any hidden layer of the neural network may be used as features which are compressed representations of data inputted to nodes of the input layer of the neural network.

FIG. 11 is a flow diagram of a method of processing data representing an actual phenomenon by using a neural network configured to model an actual data pattern. FIG. 11 illustrates the processing associated with the respective nodes of the output layer of the neural network, omitting the processing associated with each node of the at least one hidden layer of the neural network.

In Step S1110, each node of the output layer of the neural network calculates the weighted sum of the input values. The input values at each node of the output layer are output values from the nodes of the last hidden layer of the at least one hidden layer of the neural network.

In S1120, each node of the output layer of the neural network applies a nonlinear activation function to the weighted sum of the input values to generate output values. Here, the nonlinear activation function has an output range with an upper limit and a lower limit that are respectively bounded by a maximum value and a minimum value of input data inputted to the relevant node of the input layer of the neural network. The nonlinear activation function may be expressed by Equation 1 or Equation 4 described above.

In applications related to anomaly detection, the method may further include Step S1130 of detecting anomaly data in the data representing the actual phenomenon based on the difference between the data inputted to each node of the input layer of the neural network and the output value generated at each node of the output layer of the neural network.

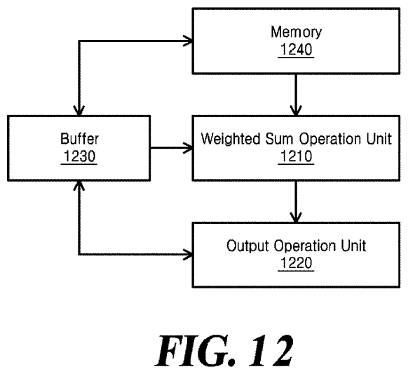

In some examples, the processes described in this disclosure may be performed by special purpose logic circuitry, such as a field-programmable gate array (FPGA) or an application-specific integrated circuit (ASIC), and the units described in this disclosure may be implemented with special purpose logic circuitry. An example of such an implementation will be described with reference to FIG. 12.

FIG. 12 is an exemplary functional block diagram of a neural network processing apparatus for performing neural network operations. A neural network operation may be an operation for a neural network configured to model an actual data pattern to process data representing an actual phenomenon. The apparatus illustrated in FIG. 12 includes a weighted sum operation unit 1210, an output operation unit 1220, a buffer 1230, and a memory 1340.

The weighted sum operation unit 1210 is configured to receive a plurality of input values and a plurality of weights sequentially for a plurality of layers of a neural network (e.g., an autoencoder such as FIG. 5) and to generate a plurality of cumulative values (i.e., weighted sums of input values for the respective nodes of the relevant layer) based on the plurality of input values and the plurality of weights. In particular, based on input values and weights for nodes of the output layer of the neural network, the weighted sum operation unit 1210 may generate cumulative values for the nodes of the output layer. Here, the input values for the respective nodes of the output layer of the neural network are output values from the nodes of the last hidden layer of the at least one hidden layer of the neural network. The weighted sum operation unit 1210 may include a plurality of multiplication circuits and a plurality of summing circuits.

The output operation unit 1220 is configured to operate sequentially for the plurality of layers of the neural network to apply an activation function to each cumulative value generated by the weighted sum operation unit 1210, thereby generating output values for the respective layers. In particular, the output operation unit 1220 applies a nonlinear activation function to the cumulative sum of each node of the output layer of the neural network to generate output value. Here, the nonlinear activation function has an output range with an upper limit and a lower limit that are respectively bounded by a maximum value and a minimum value of data inputted to the nodes of the input layer of the neural network. The nonlinear activation function may be expressed by Equation 1 or Equation 4 described above

The buffer 1230 is configured to receive and store the output from the output operation unit and to send the received output as an input to the weighted sum operation unit 1210. The memory 1240 is configured to store a plurality of weights for the respective layers of the neural network and to transmit the stored weights to the weighted sum operation unit 1210. The memory 1240 may be configured to store a data set representing an actual phenomenon to be processed through a neural network operation.

It is to be understood that the illustrative embodiments described above may be implemented in many different ways. In some examples, the various methods and apparatuses described in this disclosure may be implemented by a general-purpose computer having a processor, memory, disk, or other mass storage, communication interface, input/output devices, and other peripherals. The general-purpose computer may work as an apparatus for performing the method described above by loading software instructions into the processor and then executing the instructions to perform the functions described in this disclosure.

The steps illustrated in FIG. 11 can be implemented with instructions stored in a non-transitory recording medium, which can be read and executed by one or more processors. A non-transitory storage medium includes, for example, all kinds of recording devices in which data is stored in a form readable by a computer system. For example, the non-transitory recording medium includes a magnetic storage medium (e.g., a ROM, a floppy disk, a hard disk, etc.) and a storage medium such as an optically readable medium (e.g., a CD-ROM, a DVD, etc.).

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. A method, implemented by a computer, for processing data representing an actual phenomenon by using a neural network configured to model an actual data pattern, the method comprising:
at each node of an output layer of the neural network, computing weighted sum of input values, the input values at each node of the output layer of the neural network being output values from nodes of a last hidden layer of at least one hidden layer of the neural network; and
at each nodes of the output layer of the neural network, applying a nonlinear activation function to the weighted sum of the input values to generate output value, wherein
the nonlinear activation function has an output range with an upper limit and a lower limit that are respectively bounded by a maximum value and a minimum value of a variable to be predicted at a relevant node of the output layer of the neural network.

2. The method of claim 1, wherein the nonlinear activation function is expressed by an equation:
$$f ( x ) = \{ \begin{matrix}tanh ( \frac{x}{max / s} ) \times max & if x > 0 \\ tanh ( \frac{x}{min / s} ) \times min & else\end{matrix} , \qquad$$
wherein
x is a weighted sum of the input values at the relevant node of the output layer of the neural network, max and min are respectively the maximum value and the minimum value of the variable to be predicted at the relevant node of the output layer of the neural network, and s is a parameter that adjusts a derivative of the nonlinear activation function.

3. The method of claim 2, wherein the variable to be predicted at the relevant node of the output layer of the neural network is data inputted to a relevant node of an input layer of the neural network.

4. The method of claim 2, wherein the parameter is set to a hyper-parameter or to be learned from training data.

5. The method of claim 1, wherein the nonlinear activation function is expressed by an equation:
$$f ( x ) = \{ \begin{matrix}tanh ( \frac{x}{max} ) \times max & if x > 0 \\ tanh ( \frac{x}{min} ) \times min & else\end{matrix} ,$$
wherein
x is a weighted sum of the input values at the relevant node of the output layer, and max and min are respectively the maximum value and the minimum value of the variable to be predicted at the relevant node of the output layer of the neural network.

6. The method of claim 1, further comprising:
detecting anomaly data out of the data representing the actual phenomenon based on a difference between data inputted to each node of an input layer of the neural network and an output value generated at each node of the output layer of the neural network.

7. The method of claim 1, further comprising:
utilizing output values from nodes of any hidden layer of the at least one hidden layer of the neural network as compressed representations of data inputted to nodes of an input layer of the neural network.

8. An apparatus for processing data representing an actual phenomenon by using a neural network configured to model an actual data pattern, the apparatus comprising:
at least one processor; and
at least one memory in which instructions are recorded, wherein
the instructions cause, when executed in the processor, the processor to perform steps comprising:
at each node of an output layer of the neural network, computing weighted sum of input values, the input values at each node of the output layer of the neural network being output values from nodes of a last hidden layer of at least one hidden layer of the neural network; and
at each node of the output layer of the neural network, applying a nonlinear activation function to the weighted sum of the input values to generate output value, wherein
the nonlinear activation function has an output range with an upper limit and a lower limit that are respectively bounded by a maximum value and a minimum value of a variable to be predicted at a relevant node of the output layer of the neural network.

9. The apparatus of claim 8, wherein the nonlinear activation function is expressed by an equation:
$$f ( x ) = \{ \begin{matrix}tanh ( \frac{x}{max / s} ) \times max & if x > 0 \\ tanh ( \frac{x}{min / s} ) \times min & else\end{matrix} ,$$
wherein
x is a weighted sum of the input values at the relevant node of the output layer, max and min are respectively the maximum value and the minimum value of the variable to be predicted at the relevant node of the output layer of the neural network, and s is a parameter that adjusts a derivative of the nonlinear activation function.

10. The apparatus of claim 8, wherein the nonlinear activation function is expressed by an equation:
$$f ( x ) = \{ \begin{matrix}tanh ( \frac{x}{max} ) \times max & if x > 0 \\ tanh ( \frac{x}{min} ) \times min & else\end{matrix} ,$$
wherein
x is a weighted sum of the input values at the relevant node of the output layer, and max and min are respectively the maximum value and the minimum value of the variable to be predicted at the relevant node of the output layer of the neural network.

11. An apparatus for performing a neural network operation for a neural network configured to model an actual data pattern to process data representing an actual phenomenon, the apparatus comprising:
a weighted sum operation unit configured to receive input values and weights for nodes of an output layer of the neural network and to generate a plurality of weighted sums for the nodes of the output layer of the neural network based on the input values and the weights that are received, the input values at each node of the output layer of the neural network being output values from nodes of a last hidden layer of at least one hidden layer of the neural network; and
an output operation unit configured to apply an activation function to weighted sums of the respective nodes of the output layer of the neural network to generate output values for the respective nodes of the output layer of the neural network, wherein
the nonlinear activation function has an output range with an upper limit and a lower limit that are respectively bounded by a maximum value and a minimum value of a variable to be predicted at a relevant node of the output layer of the neural network.

12. The apparatus of claim 11, wherein the nonlinear activation function is expressed by an equation:
$$f ( x ) = \{ \begin{matrix}tanh ( \frac{x}{max / s} ) \times max & if x > 0 \\ tanh ( \frac{x}{min / s} ) \times min & else\end{matrix} ,$$
wherein
x is a weighted sum of the input values at the relevant node of the output layer of the neural network, max and min are respectively the maximum value and the minimum value of the variable to be predicted at the relevant node of the output layer of the neural network, and s is a parameter that adjusts a derivative of the nonlinear activation function.

13. The apparatus of claim 11, wherein the nonlinear activation function is expressed by an equation:
$$f ( x ) = \{ \begin{matrix}tanh ( \frac{x}{max} ) \times max & if x > 0 \\ tanh ( \frac{x}{min} ) \times min & else\end{matrix} ,$$
wherein
x is a weighted sum of the input values at the relevant node of the output layer, and max and min are respectively the maximum value and the minimum value of the variable to be predicted at the relevant node of the output layer of the neural network.
